(19) United States
(12) Patent Application Publication
(10) Pub. No.: US 2023/0416644 A1
(43) Pub. Date: Dec. 28, 2023

(54) LIQUID HAND DISHWASHING CLEANING COMPOSITION

(71) Applicant: The Procter & Gamble Company, Cincinnati, OH (US)

(72) Inventors: Annalaura DEL REGNO, Mannheim (DE); Sophia Rosa EBERT, Mannheim (DE); Hayat EL KAH, Brussels (BE); Denis Alfred GONZALES, Brussels (BE); Jeremie Robert Marcel GUMMEL, Ixelles (BE); Frank HULSKOTTER, Birkenheide (DE); Dawid MARCZEWSKI, Limburgerhof (DE); Marc René Bert RENMANS, Strombeek-Bever (BE)

(21) Appl. No.: 18/213,918

(22) Filed: Jun. 26, 2023

(30) Foreign Application Priority Data
Jun. 27, 2022 (EP) 22181241.5
Mar. 9, 2023 (EP) 23161005.6

(51) Int. Cl. C11D 1/94; C11D 3/30; C11D 1/14; C11D 17/08; C11D 11/00

(52) U.S. Cl. CPC C11D 1/94; C11D 3/30; C11D 1/146; C11D 17/08; C11D 11/0023

(57) ABSTRACT

The need for a liquid detergent composition for washing dishes which provides effective removal of both crystalline and polymerised grease, while requiring less time and effort to clean and rinse the dishes, is met when the composition is formulated with a surfactant system having an anionic surfactant, a co-surfactant, and a non-alkoxylated esteramine.

### FIELD OF THE INVENTION

The present invention relates to a liquid hand dishwashing cleaning composition.

### BACKGROUND OF THE INVENTION

Liquid detergent compositions for use in manual dishwashing applications have to be able to clean a variety of soils from dishes and tableware. Such soils include particulates, food remnants and grease. Crystalline grease soils and polymerised grease soils are particularly challenging to remove. Crystalline grease is grease which is solid at room temperature such as animal fats, and the like. Polymerised grease is grease which has been polymerised at high temperatures such as during baking. Typically, a high pH is needed to remove such polymerised grease. However, high pH affects surfactant packing, leading to less effective removal of crystalline grease.

In addition, it is desired to spend less time and effort washing dishes while still providing effective soil removal. The time needed to clean dishes can also be reduced by ensuring that suds and dirt residue are easily rinsed away. In other words, good initial sudsing and lasting sudsing during the manual cleaning step is desired to indicate good cleaning efficacy but the suds should collapse rapidly during rinsing. Suds collapse has been found to be especially challenging when rinsing with soft water or water having low hardness since divalent ions such as calcium and magnesium ions sequester anionic surfactants and hence reduce sudsing during rinsing.

As such, a need remains for a liquid detergent composition suitable for washing dishes which provides effective removal of both crystalline and polymerised grease, while requiring less time and effort to clean and especially to rinse the dishes, regardless of water hardness.

EP2940115A relates to a cleaning composition comprising a cleaning amine which provides good cleaning, in particular good grease cleaning. WO2019/010368A relates to cleaning compositions that include non-alkoxylated esteramines, as well as to methods of preparation and use. While WO2019/010368 A discloses the use of such compositions for a variety of cleaning applications, including dish, the application is primarily directed to detergent compositions for use in laundry applications for removing greasy soils at low temperatures. Since WO2019/010368A is directed to the removal of grease primarily during laundry use, there is no mention of the benefit of the esteramines described therein, for improving the removal of polymerised or baked on grease. EP application 22181164.9 (BASF SE) relates to a process for the preparation of an esteramine mixture (EAM) comprising the step of reacting a reaction mixture (RM) comprising as components (A) at least one trialkanolamine, (B) at least one branched carboxylic acid, and (C) at least one acid catalyst, wherein per mole of component (A) 1.1 to 2.9 mole of component (B) is present in the reaction mixture (RM). JP2013010902A relates to foam increasing agents to be used together with a foaming surfactant; and to detergent compositions including them, the foam increasing agent including a tertiary amine compound.

### SUMMARY OF THE INVENTION

The present invention relates to a liquid hand dishwashing cleaning composition comprising from 5% to 50% by weight of the total composition of a surfactant system wherein the surfactant system comprises: an anionic surfactant; a co-surfactant selected from the group consisting of an amphoteric surfactant, a zwitterionic surfactant, and mixtures thereof; and from 0.1% to 10% by weight of the composition of a non-alkoxylated esteramine, wherein the non-alkoxylated esteramine has the formula (I), or a partially or fully protonated structure thereof:

R¹—O(O)C—(CH₂)ₐ—N—(R²)₂ (I)
wherein:
R¹ is a branched or unbranched C₄-C₁₀ alkyl;
each R² is independently selected from branched or unbranched C₁-C₅ alkyl; and
index a is from 1 to 6.

The present invention further relates to the use of a liquid detergent composition for removing grease from dishware, wherein the liquid detergent composition comprises: an anionic surfactant; a co-surfactant selected from the group consisting of an amphoteric surfactant, a zwitterionic surfactant, and mixtures thereof; and an esteramine, wherein the esteramine has the formula (II):

R¹—O(O)C—(CH₂)ₐ—N—(R²)₂ (II)
wherein:
R¹ is a branched or unbranched C₃-C₁₆ alkyl;
each R² is independently selected from branched or unbranched C₁-C₅ alkyl; and
index a is from 1 to 6.

### DETAILED DESCRIPTION OF THE INVENTION

Formulating the non-alkoxylated esteramine based technologies, as described herein, has been found to improve grease cleaning while also facilitating an easier rinsing of the initial suds being formed. The liquid hand dishwashing cleaning compositions of the present invention provide a good sudsing profile, including high initial suds volume generation and sustained suds stabilization through the dishwashing process, even when in presence of greasy and/or particulate soils. This signals to the user that there remains sufficient active ingredients present to provide continued cleaning performance, as such triggering less re-dosing and overconsumption of the product by the user. Despite delivering strong suds stabilization during the washing step, the suds have been found to rinse away more easily in presence of the non-alkoxylated esteramine of use in the present invention.

The compositions of the present invention also provide good grease removal, in particular good removal of uncooked grease and particulate soils.

### Definitions

As used herein, articles such as “a” and “an” when used in a claim, are understood to mean one or more of what is claimed or described.

The term “comprising” as used herein means that steps and ingredients other than those specifically mentioned can be added. This term encompasses the terms “consisting of” and “consisting essentially of.” The compositions of the present invention can comprise, consist of, and consist essentially of the essential elements and limitations of the invention described herein, as well as any of the additional or optional ingredients, components, steps, or limitations described herein.

The term “dishware” as used herein includes cookware and tableware made from, by non-limiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease in the material) saturated and unsaturated fats and oils, preferably oils and fats derived from animal sources such as beef, pig and/or chicken.

The terms “include”, “includes” and “including” are meant to be non-limiting.

The term “particulate soils” as used herein means inorganic and especially organic, solid soil particles, especially food particles, such as for non-limiting examples: finely divided elemental carbon, baked grease particle, and meat particles.

The term “sudsing profile” as used herein refers to the properties of a cleaning composition relating to suds character during the dishwashing process. The term “sudsing profile” of a cleaning composition includes initial suds volume generated upon dissolving and agitation, typically manual agitation, of the cleaning composition in the aqueous washing solution, and the retention of the suds during the dishwashing process. Preferably, hand dishwashing cleaning compositions characterized as having “good sudsing profile” tend to have high initial suds volume and/or sustained suds volume, particularly during a substantial portion of or for the entire manual dishwashing process. This is important as the consumer uses high suds as an indicator that sufficient cleaning composition has been dosed. Moreover, the consumer also uses the sustained suds volume as an indicator that sufficient active cleaning ingredients (e.g., surfactants) are present, even towards the end of the dishwashing process. The consumer usually renews the washing solution when the sudsing subsides. Thus, a low sudsing cleaning composition will tend to be replaced by the consumer more frequently than is necessary because of the low sudsing level.

It is understood that the test methods that are disclosed in the Test Methods Section of the present application must be used to determine the respective values of the parameters of Applicants' inventions as described and claimed herein.

All percentages are by weight of the total composition, as evident by the context, unless specifically stated otherwise. All ratios are weight ratios, unless specifically stated otherwise, and all measurements are made at 25° C., unless otherwise designated.

### Cleaning Composition

The cleaning composition is a hand dishwashing cleaning composition in liquid form. The cleaning composition is preferably an aqueous cleaning composition. As such, the composition can comprise from 50% to 85%, preferably from 50% to 75%, by weight of the total composition of water.

Preferably, the pH of the composition is from 6 to 14, preferably from 7 to 12, or more preferably from 8.0 to 10, as measured at a 10% concentration in distilled water at 20° C. The pH of the composition can be adjusted using pH modifying ingredients known in the art. At lower and higher pH, the non-alkoxylated esteramines of use in the present invention hydrolyze at a higher rate.

The reserve alkalinity can be from 0.1 to 1.0, more preferably from 0.1 to 0.5. Reserve alkalinity is herein expressed as grams of NaOH/100 ml of composition required to titrate product from a pH 7.0 to the pH of the finished composition. This pH and reserve alkalinity further contribute to the cleaning of tough food soils.

The composition of the present invention can be Newtonian or non-Newtonian, preferably Newtonian. Preferably, the composition has a viscosity of from 10 mPa·s to 10,000 mPa·s, preferably from 100 mPa·s to 5,000 mPa·s, more preferably from 300 mPa·s to 2,000 mPa·s, or most preferably from 500 mPa·s to 1,500 mPa·s, alternatively combinations thereof. The viscosity is measured at 20° C. with a Brookfield RT Viscometer using spindle 31 with the RPM of the viscometer adjusted to achieve a torque of between 40% and 60%.

### Surfactant System

The cleaning composition comprises from 5% to 50%, preferably from 8% to 45%, most preferably from 15% to 40%, by weight of the total composition of a surfactant system. The surfactant system comprises an anionic surfactant and a non-alkoxylated esteramine.

### Anionic surfactant

The surfactant system comprises an anionic surfactant. The composition preferably comprises from 5.0% to 35%, more preferably from 10% to 30% and especially from 15% to 25% by weight of the cleaning composition of the anionic surfactant. The surfactant system can comprise at least 40%, preferably from 50% to 90%, more preferably from 65% to 85% by weight of the surfactant system of the anionic surfactant. The surfactant system is preferably free of fatty acid or salt thereof, since such fatty acids impede the generation of suds.

The anionic surfactant can comprise at least 70% by weight of the anionic surfactant of alkyl sulfated anionic surfactant. The anionic surfactant preferably comprises at least 80%, preferably at least 90%, preferably 100% by weight of the anionic surfactant of alkyl sulfated anionic surfactant. The alkyl sulfated anionic surfactant can be alkoxylated or free of alkoxylation.

The anionic surfactant preferably comprises, more preferably consists of a sulfated anionic surfactant selected from at least one alkyl sulfate, at least one alkyl ethoxy sulfate, or a mixture of at least one alkyl sulfate and at least one alkyl ethoxy sulfate. The surfactant system also comprises a co-surfactant selected from an amphoteric co-surfactant, a zwitterionic co-surfactant, and mixtures thereof.

The mol average alkyl chain length of the alkyl sulfated anionic surfactant can be from 8 to 18, preferably from 10 to 14, more preferably from 12 to 14, most preferably from 12 to 13 carbon atoms, in order to provide a combination of improved grease removal and enhanced speed of cleaning.

The alkyl chain of the alkyl sulfated anionic surfactant can have a mol fraction of C12 and C13 chains of at least 50%, preferably at least 65%, more preferably at least 80%, most preferably at least 90%. Suds mileage is particularly improved, especially in the presence of greasy soils, when the C13/C12 mol ratio of the alkyl chain is at least 57/43, preferably from 60/40 to 90/10, more preferably from 60/40 to 80/20, most preferably from 60/40 to 70/30, while not compromising suds mileage in the presence of particulate soils.

The relative molar amounts of C13 and C12 alkyl chains in the alkyl sulfated anionic surfactant can be derived from the carbon chain length distribution of the anionic surfactant. The carbon chain length distribution of the alkyl chains of the alkyl sulfated anionic surfactants can be obtained from the technical data sheets from the suppliers for the surfactant or constituent alkyl alcohol. Alternatively, the chain length distribution and average molecular weight of the fatty alcohols, used to make the alkyl sulfated anionic surfactant, can also be determined by methods known in the art. Such methods include capillary gas chromatography with flame ionisation detection on medium polar capillary column, using hexane as the solvent. The chain length distribution is based on the starting alcohol and alkoxylated alcohol. As such, the alkyl sulfated anionic surfactant should be hydrolysed back to the corresponding alkyl alcohol and alkyl alkoxylated alcohol before analysis, for instance using hydrochloric acid.

Preferably the alkyl sulfated anionic surfactant has an average degree of alkoxylation of less than 3.5, preferably from 0.3 to 2.0, more preferably from 0.5 to 0.9, in order to improve low temperature physical stability and improve suds mileage of the compositions of the present invention.

The average degree of alkoxylation is the mol average degree of alkoxylation (i.e., mol average alkoxylation degree) of all the alkyl sulfated anionic surfactant. Hence, when calculating the mol average alkoxylation degree, the mols of non-alkoxylated alkyl sulfate anionic surfactant are included:

Mol average alkoxylation degree=(x1*alkoxylation degree of surfactant 1+x2*alkoxylation degree of surfactant 2+ . . . )/(x1+x2+ . . . )

wherein x1, x2, . . . are the number of moles of each alkyl (or alkoxy) sulfate anionic surfactant of the mixture and alkoxylation degree is the number of alkoxy groups in each alkyl sulfated anionic surfactant.

Preferred alkyl alkoxy sulfates are alkyl ethoxy sulfates

The alkyl sulfated anionic surfactant can have a weight average degree of branching of more than 10%, preferably more than 20%, more preferably more than 30%, even more preferably between 30% and 60%, most preferably between 30% and 50%. The alkyl sulfated anionic surfactant can comprise at least 5%, preferably at least 10%, most preferably at least 25%, by weight of the alkyl sulfated anionic surfactant, of branching on the C2 position (as measured counting carbon atoms from the sulfate group for non-alkoxylated alkyl sulfate anionic surfactants, and the counting from the alkoxy-group furthest from the sulfate group for alkoxylated alkyl sulfate anionic surfactants). More preferably, greater than 75%, even more preferably greater than 90%, by weight of the total branched alkyl content consists of C1-C5 alkyl moiety, preferably C1-C2 alkyl moiety. It has been found that formulating the inventive compositions using alkyl sulfated surfactants having the aforementioned degree of branching results in improved low temperature stability. Such compositions require less solvent in order to achieve good physical stability at low temperatures. As such, the compositions can comprise lower levels of organic solvent, of less than 5.0% by weight of the cleaning composition of organic solvent, while still having improved low temperature stability. Higher surfactant branching also provides faster initial suds generation, but typically less suds mileage. The weight average branching, described herein, has been found to provide improved low temperature stability, initial foam generation and suds longevity.

The weight average degree of branching for an anionic surfactant mixture can be calculated using the following formula:

Weight average degree of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material before (alkoxylation and) sulfation to produce the alkyl (alkoxy) sulfate anionic surfactant. In the weight average degree of branching calculation, the weight of the alkyl alcohol used to form the alkyl sulfated anionic surfactant which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionisation detection on medium polar capillary column, using hexane as the solvent. The weight average degree of branching and the distribution of branching is based on the starting alcohol used to produce the alkyl sulfated anionic surfactant.

Suitable counterions include alkali metal cation earth alkali metal cation, alkanolammonium or ammonium or substituted ammonium, but preferably sodium.

Suitable examples of commercially available alkyl sulfated anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols can be blended in order to achieve the desired mol fraction of C12 and C13 chains and the desired C13/C12 ratio, based on the relative fractions of C13 and C12 within the starting alcohols, as obtained from the technical data sheets from the suppliers or from analysis using methods known in the art.

The performance can be affected by the width of the alkoxylation distribution of the alkoxylated alkyl sulfate anionic surfactant, including grease cleaning, sudsing, low temperature stability and viscosity of the finished product. The alkoxylation distribution, including its broadness can be varied through the selection of catalyst and process conditions when making the alkoxylated alkyl sulfate anionic surfactant.

If ethoxylated alkyl sulfate is present, without wishing to be bound by theory, through tight control of processing conditions and feedstock material compositions, both during alkoxylation especially ethoxylation and sulfation steps, the amount of 1,4-dioxane by-product within alkoxylated especially ethoxylated alkyl sulfates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. Processes to control 1,4-dioxane content within alkoxylated/ethoxylated alkyl sulfates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl)-phenyl]-2-(1-H)-pyridone, 3-α-hydroxy-7-oxo stereoisomer-mixtures of cholinic acid, 3-(N-methyl amino)-L-alanine, and mixtures thereof.

The surfactant system may comprise further anionic surfactant, including sulfonate anionic surfactants such as HLAS, or sulfosuccinate anionic surfactants. However, the composition preferably comprises less than 30%, preferably less than 15%, more preferably less than 10% by weight of the surfactant system of further anionic surfactant. Most preferably, the surfactant system comprises no further anionic surfactant, other than the alkyl sulfated anionic surfactant.

### Non-Alkoxylated Esteramine

The surfactant system comprises at least one non-alkoxylated esteramine and/or its protonated structure thereof. It has been found that the non-alkoxylated esteramines of use in the present invention boost both polymerized and crystalline grease cleaning performance of cleaning products, especially liquid dishwashing detergents. In addition to the improved grease cleaning, the non-alkoxylated esteramines have been found to speed suds rinsing.

The surfactant system includes from 0.1% to 10%, preferably from 0.3% to 5%, more preferably from 0.5% to 2.0%, by weight the composition, of a non-alkoxylated esteramine, and/or a protonated version thereof, or a blend thereof.

The non-alkoxylated esteramine has the Formula I, or a partially or fully protonated structure thereof:

R¹—O(O)C—(CH₂)ₐ—N—(R²)₂ (I)
wherein:
R¹ is a branched or unbranched C₄-C₁₀ alkyl;
each R² is independently selected from branched or unbranched C₁-C₅ alkyl, preferably C₁-C₃ alkyl, more preferably C₁ alkyl; and
index a is from 1 to 6, preferably from 1 to 5, more preferably from 2 to 5.

Most preferably both R² groups are identical.

The non-alkoxylated esteramine is preferably at least partially in its protonated form, for example where the nitrogen group is protonated. Whether the non-alkoxylated esteramine is in its non-protonated form, at least partially in its protonated form, or fully in its protonated form typically depends on the pH of the composition.

The non-alkoxylated esteramine may be selected from a compound having a structure as shown in structures A to D below, or mixtures thereof, with the non-alkoxylated esteramine being present in its protonated form or non-protonated form or a mixture thereof. The compounds are shown below in their non-protonated forms, but it is recognized that the non-alkoxylated esteramine may be present in the compositions of the present disclosure in protonated form, or in mixtures of protonated and non-protonated forms, as defined by the pH of the respective formulation or wash solutions thereof. The non-alkoxylated esteramine is preferably selected from the group consisting of: 3,5,5-trimethylhexyl 4-(dimethylamino)butanoate, tert-butyl 4-(dimethylamino)butanoate, butyl 6-(dimethylamino)hexanoate, 2-ethylhexyl 6-(dimethylamino)hexanoate, and mixtures thereof, preferably 2-ethylhexyl 6-(dimethylamino)hexanoate

TABLE 1
Esteramines of use in the present invention

| # | Name | Formula |
|---|---|---|
| A | 3,5,5-trimethylhexyl 4-(dimethylamino)butanoate | 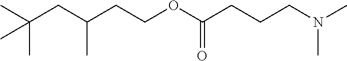 [SMILES: CC(CCOC(=O)CCCN(C)C)CC(C)(C)C] |
| B | tert-butyl 4-(dimethylamino)butanoate | 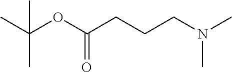 |
| C | butyl 6-(dimethylamino)hexanoate | 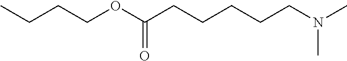 |
| D | 2-ethylhexyl 6-(dimethylamino)hexanoate | 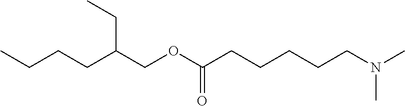 [SMILES: CCCCC(CC)COC(=O)CCCCCN(C)C] |

### Co-Surfactant

The composition preferably comprises from 0.1% to 20%, more preferably from 0.5% to 15% and especially from 2.0% to 10% by weight of the cleaning composition of the co-surfactant. The surfactant system of the cleaning composition of the present invention preferably comprises up to 50%, preferably from 10% to 40%, more preferably from 15% to 35%, by weight of the surfactant system of a co-surfactant.

In order to improve surfactant packing after dilution and hence improve suds mileage, the surfactant system comprises a co-surfactant. The alkyl sulfated anionic surfactant to the co-surfactant weight ratio can be from 1:1 to 8:1, preferably from 2:1 to 5:1, more preferably from 2.5:1 to 4:1.

The co-surfactant is selected from the group consisting of an amphoteric surfactant, a zwitterionic surfactant, and mixtures thereof. The co-surfactant is preferably an amphoteric surfactant, more preferably an amine oxide surfactant.

The amine oxide surfactant can be linear or branched, though linear are preferred. Suitable linear amine oxides are typically water-soluble, and characterized by the formula R1-N(R2)(R3) O wherein R1 is a C8-18 alkyl, and the R2 and R3 moieties are selected from the group consisting of C1-3 alkyl groups, C1-3 hydroxyalkyl groups, and mixtures thereof. For instance, R2 and R3 can be selected from the group consisting of: methyl, ethyl, propyl, isopropyl, 2-hydroxethyl, 2-hydroxypropyl and 3-hydroxypropyl, and mixtures thereof, though methyl is preferred for one or both of R2 and R3. The linear amine oxide surfactants in particular may include linear C10-C18 alkyl dimethyl amine oxides and linear C8-C12 alkoxy ethyl dihydroxy ethyl amine oxides.

Preferably, the amine oxide surfactant is selected from the group consisting of: alkyl dimethyl amine oxide, alkyl amido propyl dimethyl amine oxide, and mixtures thereof. Alkyl dimethyl amine oxides are particularly preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, and mixtures thereof. C12-C14 alkyl dimethyl amine oxide are particularly preferred.

Alternative suitable amine oxide surfactants include mid-branched amine oxide surfactants. As used herein, “mid-branched” means that the amine oxide has one alkyl moiety having n1 carbon atoms with one alkyl branch on the alkyl moiety having n2 carbon atoms. The alkyl branch is located on the α carbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as C1 alkyl.

Alternatively, the amine oxide surfactant can be a mixture of amine oxides comprising a mixture of low-cut amine oxide and mid-cut amine oxide. The amine oxide of the composition of the invention can then comprises:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls and mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl, with preferably both R1 and R2 being methyl. In the mid-cut amine oxide of formula R4R5R6AO, R4 and R5 are preferably both methyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

Suitable zwitterionic surfactants include betaine surfactants. Such betaine surfactants includes alkyl betaines, alkylamidobetaine, amidazoliniumbetaine, sulfobetaine (INCI Sultaines) as well as the phosphobetaine, and preferably meets formula (I):

R¹—[CO—X(CH₂)ₙ]ₓ—N⁺(R²)(R₃)—(CH₂)ₘ—[CH(OH)—CH₂]_{y}—Y⁻

Wherein in formula (I),
R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue;
X is selected from the group consisting of: NH, NR4 wherein R4 is a C1-4 alkyl residue, O, and S,
n is an integer from 1 to 10, preferably 2 to 5, more preferably 3,
x is 0 or 1, preferably 1,
R2 and R3 are independently selected from the group consisting of: a C1-4 alkyl residue, hydroxy substituted such as a hydroxyethyl, and mixtures thereof, preferably both R2 and R3 are methyl,
m is an integer from 1 to 4, preferably 1, 2 or 3,
y is 0 or 1, and
Y is selected from the group consisting of: COO, SO3, OPO(OR5)O or P(O)(OR5)O, wherein R5 is H or a C1-4 alkyl residue.

Preferred betaines are the alkyl betaines of formula (Ia), the alkyl amido propyl betaine of formula (Ib), the sulfo betaines of formula (Ic) and the amido sulfobetaine of formula (Id):

R¹—N⁺(CH₃)₂—CH₂COO⁻ (IIa)

R¹—CO—NH—(CH₂)₃—N⁺(CH₃)₂—CH₂COO⁻ (IIb)

R¹—N⁺(CH₃)₂—CH₂CH(OH)CH₂SO₃⁻ (IIc)

R¹—CO—NH—(CH₂)₃—N⁺(CH₃)₂—CH₂CH(OH)CH₂SO₃⁻ (IId)

in which R1 has the same meaning as in formula (I). Particularly preferred are the carbobetaines [i.e. wherein Y—═COO— in formula (I)] of formulae (Ia) and (Ib), more preferred are the alkylamidobetaine of formula (Ib).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

### Nonionic Surfactant

The surfactant system can further comprise a nonionic surfactant. Suitable nonionic surfactants include alkoxylated alcohol nonionic surfactants, alkyl polyglucoside nonionic surfactants, and mixtures thereof.

### Alkoxylated Alcohol Nonionic Surfactant

Preferably, the surfactant system of the composition of the present invention further comprises from 1% to 25%, preferably from 1.25% to 20%, more preferably from 1.5% to 15%, most preferably from 1.5% to 5%, by weight of the surfactant system, of an alkoxylated alcohol non-ionic surfactant.

Preferably, the alkoxylated alcohol non-ionic surfactant is a linear or branched, primary or secondary alkyl alkoxylated non-ionic surfactant, preferably an alkyl ethoxylated non-ionic surfactant, preferably comprising on average from 9 to 15, preferably from 10 to 14 carbon atoms in its alkyl chain and on average from 5 to 12, preferably from 6 to 10, most preferably from 7 to 8, units of ethylene oxide per mole of alcohol.

### Alkyl Polyglucoside Nonionic Surfactant

The compositions of the present invention can comprise alkyl polyglucoside (“APG”) surfactant. The addition of alkyl polyglucoside surfactants has been found to improve sudsing beyond that of comparative nonionic surfactants such as alkyl ethoxylated nonionic surfactants. If present, the alkyl polyglucoside can be present in the surfactant system at a level of from 0.5% to 20%, preferably from 0.75% to 15%, more preferably from 1% to 10%, most preferably from 1% to 5% by weight of the surfactant composition. Preferably the alkyl polyglucoside surfactant is a C8-C16 alkyl polyglucoside surfactant, preferably a C8-C14 alkyl polyglucoside surfactant. The alkyl polyglucoside preferably has an average degree of polymerization of between 0.1 and 3, more preferably between 0.5 and 2.5, even more preferably between 1 and 2. Most preferably, the alkyl polyglucoside surfactant has an average alkyl carbon chain length between 10 and 16, preferably between 10 and 14, most preferably between 12 and 14, with an average degree of polymerization of between 0.5 and 2.5 preferably between 1 and 2, most preferably between 1.2 and 1.6.

C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation).

### Further Ingredients

The composition can comprise further ingredients such as those selected from: amphiphilic alkoxylated polyalkyleneimines, cyclic polyamines, triblock copolymers, salts, hydrotropes, organic solvents, other adjunct ingredients such as those described herein, and mixtures thereof.

### Amphiphilic Alkoxylated Polyalkyleneimine

The composition of the present invention may further comprise from 0.05% to 2%, preferably from 0.07% to 1% by weight of the total composition of an amphiphilic polymer. Suitable amphiphilic polymers can be selected from the group consisting of: amphiphilic alkoxylated polyalkyleneimine and mixtures thereof. The amphiphilic alkoxylated polyalkyleneimine polymer has been found to reduce gel formation on the hard surfaces to be cleaned when the liquid composition is added directly to a cleaning implement (such as a sponge) before cleaning and consequently brought in contact with heavily greased surfaces, especially when the cleaning implement comprises a low amount to nil water such as when light pre-wetted sponges are used.

A preferred amphiphilic alkoxylated polyethyleneimine polymer has the general structure of formula (I):

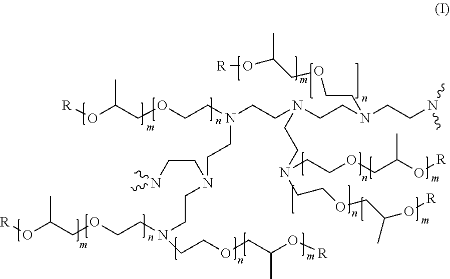

wherein the polyethyleneimine backbone has a weight average molecular weight of 600, n of formula (I) has an average of 10, m of formula (I) has an average of 7 and R of formula (I) is selected from hydrogen, a C₁-C₄ alkyl and mixtures thereof, preferably hydrogen. The degree of permanent quaternization of formula (I) may be from 0% to 22% of the polyethyleneimine backbone nitrogen atoms. The molecular weight of this amphiphilic alkoxylated polyethyleneimine polymer preferably is between 10,000 and 15,000 Da.

More preferably, the amphiphilic alkoxylated polyethyleneimine polymer has the general structure of formula (I) but wherein the polyethyleneimine backbone has a weight average molecular weight of 600 Da, n of Formula (I) has an average of 24, m of Formula (I) has an average of 16 and R of Formula (I) is selected from hydrogen, a C₁-C₄ alkyl and mixtures thereof, preferably hydrogen. The degree of permanent quaternization of Formula (I) may be from 0% to 22% of the polyethyleneimine backbone nitrogen atoms and is preferably 0%. The molecular weight of this amphiphilic alkoxylated polyethyleneimine polymer preferably is between 25,000 and 30,000, most preferably 28,000 Da.

The amphiphilic alkoxylated polyethyleneimine polymers can be made by the methods described in more detail in PCT Publication No. WO 2007/135645.

Cyclic Polyamine

The composition can comprise a cyclic polyamine having amine functionalities that helps cleaning. The composition of the invention preferably comprises from 0.1% to 3%, more preferably from 0.2% to 2%, and especially from 0.5% to 1%, by weight of the composition, of the cyclic polyamine.

The cyclic polyamine has at least two primary amine functionalities. The primary amines can be in any position in the cyclic amine but it has been found that in terms of grease cleaning, better performance is obtained when the primary amines are in positions 1,3. It has also been found that cyclic amines in which one of the substituents is —CH3 and the rest are H provided for improved grease cleaning performance.

Accordingly, the most preferred cyclic polyamine for use with the cleaning composition of the present invention are cyclic polyamine selected from the group consisting of: 2-methylcy clohexane-1,3-diamine, 4-methylcyclohexane-1,3-diamine and mixtures thereof. These specific cyclic polyamines work to improve suds and grease cleaning profile through-out the dishwashing process when formulated together with the surfactant system of the composition of the present invention.

Suitable cyclic polyamines can be supplied by BASF, under the Baxxodur tradename, with Baxxodur ECX-210 being particularly preferred.

A combination of the cyclic polyamine and magnesium sulfate is particularly preferred. As such, the composition can further comprise magnesium sulfate at a level of from 0.001% to 2.0%, preferably from 0.005% to 1.0%, more preferably from 0.01% to 0.5% by weight of the composition.

### Triblock Copolymer

The composition of the invention can comprise a triblock copolymer. The triblock co-polymers can be present at a level of from 0.1% to 10%, preferably from 0.5% to 7.5%, more preferably from 1% to 5%, by weight of the total composition. Suitable triblock copolymers include alkylene oxide triblock co-polymers, defined as a triblock co-polymer having alkylene oxide moieties according to Formula (I): (EO)x(PO)y(EO)x, wherein EO represents ethylene oxide, and each x represents the number of EO units within the EO block. Each x can independently be on average of from 5 to 50, preferably from 10 to 40, more preferably from 10 to 30. Preferably x is the same for both EO blocks, wherein the “same” means that the x between the two EO blocks varies within a maximum 2 units, preferably within a maximum of 1 unit, more preferably both x's are the same number of units. PO represents propylene oxide, and y represents the number of PO units in the PO block. Each y can on average be from between 28 to 60, preferably from 30 to 55, more preferably from 30 to 48.

Preferably the triblock co-polymer has a ratio of y to each x of from 3:1 to 2:1. The triblock co-polymer preferably has a ratio of y to the average x of 2 EO blocks of from 3:1 to 2:1. Preferably the triblock co-polymer has an average weight percentage of total E-O of between 30% and 50% by weight of the tri-block co-polymer. Preferably the triblock co-polymer has an average weight percentage of total PO of between 50% and 70% by weight of the triblock co-polymer. It is understood that the average total weight % of EO and PO for the triblock co-polymer adds up to 100%. The triblock co-polymer can have an average molecular weight of between 2060 and 7880, preferably between 2620 and 6710, more preferably between 2620 and 5430, most preferably between 2800 and 4700. Average molecular weight is determined using a 1H NMR spectroscopy (see Thermo scientific application note No. AN52907).

Triblock co-polymers have the basic structure ABA, wherein A and B are different homopolymeric and/or monomeric units. In this case A is ethylene oxide (EO) and B is propylene oxide (PO). Those skilled in the art will recognize the phrase “block copolymers” is synonymous with this definition of “block polymers”.

Triblock co-polymers according to Formula (I) with the specific EO/PO/EO arrangement and respective homopolymeric lengths have been found to enhances suds mileage performance of the liquid hand dishwashing detergent composition in the presence of greasy soils and/or suds consistency throughout dilution in the wash process.

Suitable EO-PO-EO triblock co-polymers are commercially available from BASF such as Pluronic® PE series, and from the Dow Chemical Company such as Tergitol™ L series. Particularly preferred triblock co-polymer from BASF are sold under the tradenames Pluronic® PE6400 (MW ca 2900, ca 40 wt % EO) and Pluronic® PE 9400 (MW ca 4600, 40 wt % EO). Particularly preferred triblock co-polymer from the Dow Chemical Company is sold under the tradename Tergitol™ L64 (MW ca 2700, ca 40 wt % EO).

Preferred triblock co-polymers are readily biodegradable under aerobic conditions.

The composition of the present invention may further comprise at least one active selected from the group consisting of: salt, hydrotrope, organic solvent, and mixtures thereof.

### Salt

The composition of the present invention may comprise from 0.05% to 2%, preferably from 0.1% to 1.5%, or more preferably from 0.5% to 1%, by weight of the total composition of a salt, preferably a monovalent or divalent inorganic salt, or a mixture thereof, more preferably selected from: sodium chloride, sodium sulfate, and mixtures thereof. Sodium chloride is most preferred.

### Hydrotrope

The composition of the present invention may comprise from 0.1% to 10%, or preferably from 0.5% to 10%, or more preferably from 1% to 10% by weight of the total composition of a hydrotrope or a mixture thereof, preferably sodium cumene sulfonate.

### Organic Solvent

The composition can comprise from 0.1% to 10%, or preferably from 0.5% to 10%, or more preferably from 1% to 10% by weight of the total composition of an organic solvent. Suitable organic solvents include organic solvents selected from the group consisting of: alcohols, glycols, glycol ethers, and mixtures thereof, preferably alcohols, glycols, and mixtures thereof. Ethanol is the preferred alcohol. Polyalkyleneglycols, especially polypropyleneglycol (PPG), are the preferred glycol. The polypropyleneglycol can have a molecular weight of from 400 to 3000, preferably from 600 to 1500, more preferably from 700 to 1300. The polypropyleneglycol is preferably poly-1,2-propyleneglycol.

### Adjunct Ingredients

The cleaning composition may optionally comprise a number of other adjunct ingredients such as builders (preferably citrate), chelants, conditioning polymers, other cleaning polymers, surface modifying polymers, structurants, emollients, humectants, skin rejuvenating actives, enzymes, carboxylic acids, scrubbing particles, perfumes, malodor control agents, pigments, dyes, opacifiers, pearlescent particles, inorganic cations such as alkaline earth metals such as Ca/Mg-ions, antibacterial agents, preservatives, viscosity adjusters (e.g., salt such as NaCl, and other mono-, di- and trivalent salts) and pH adjusters and buffering means (e.g. carboxylic acids such as citric acid, HCl, NaOH, KOH, alkanolamines, carbonates such as sodium carbonates, bicarbonates, sesquicarbonates, and alike).

### Method and Use for Washing Dishes

Liquid detergent composition comprising: an anionic surfactant, a co-surfactant selected from the group consisting of an amphoteric surfactant, a zwitterionic surfactant, and mixtures thereof; and an esteramine, wherein the esteramine has the formula (II), are particularly useful for removing grease from dishware:

R¹—O(O)C—(CH₂)ₐ—N—(R²)₂ (II)
wherein:
R¹ is a branched or unbranched C₃-C₁₆ alkyl;
each R² is independently selected from branched or unbranched C₁-C₅ alkyl; and
index a is from 1 to 6.

The invention is further directed to a method of manually washing dishware with the composition of the present invention. The method comprises the steps of delivering a composition of the present invention to a volume of water to form a wash solution and immersing the dishware in the solution. The dishware is be cleaned with the composition in the presence of water. The dishware can be rinsed. By “rinsing”, it is meant herein contacting the dishware cleaned with the process according to the present invention with substantial quantities of appropriate solvent, typically water. By “substantial quantities”, it is meant usually about 1 to about 20 L, or under running water.

The composition herein can be applied in its diluted form. Soiled dishware are contacted with an effective amount, typically from about 0.5 mL to about 20 mL (per about 25 dishes being treated), preferably from about 3 mL to about 10 mL, of the cleaning composition, preferably in liquid form, of the present invention diluted in water. The actual amount of cleaning composition used will be based on the judgment of the user, and will typically depend upon factors such as the particular product formulation of the cleaning composition, including the concentration of active ingredients in the cleaning composition, the number of soiled dishes to be cleaned, the degree of soiling on the dishes, and the like. Generally, from about 0.01 mL to about 150 mL, preferably from about 3 mL to about 40 mL of a cleaning composition of the invention is combined with from about 2,000 mL to about 20,000 mL, more typically from about 5,000 mL to about 15,000 mL of water in a sink. The soiled dishware are immersed in the sink containing the diluted cleaning compositions then obtained, before contacting the soiled surface of the dishware with a cloth, sponge, or similar cleaning implement. The cloth, sponge, or similar cleaning implement may be immersed in the cleaning composition and water mixture prior to being contacted with the dishware, and is typically contacted with the dishware for a period of time ranged from about 1 to about 10 seconds, although the actual time will vary with each application and user. The contacting of cloth, sponge, or similar cleaning implement to the dishware is accompanied by a concurrent scrubbing of the dishware.

Alternatively, the composition herein can be applied in its neat form to the dish to be treated. By “in its neat form”, it is meant herein that said composition is applied directly onto the surface to be treated, or onto a cleaning device or implement such as a brush, a sponge, a nonwoven material, or a woven material, without undergoing any significant dilution by the user (immediately) prior to application. “In its neat form”, also includes slight dilutions, for instance, arising from the presence of water on the cleaning device, or the addition of water by the consumer to remove the remaining quantities of the composition from a bottle. Therefore, the composition in its neat form includes mixtures having the composition and water at ratios ranging from 50:50 to 100:0, preferably 70:30 to 100:0, more preferably 80:20 to 100:0, even more preferably 90:10 to 100:0 depending on the user habits and the cleaning task.

Another aspect of the present invention is directed to use of a liquid hand dishwashing cleaning composition of the present invention for providing good sudsing profile, including suds stabilization in the presence of greasy and/or particulate soils, as well as providing good rinsing of the suds.

### Packaged Product

The liquid hand dishwashing detergent composition can be packaged in a container, typically plastic containers. Alternatively, the liquid hand dishwashing detergent composition can be packaged in recyclable cartons such as those provided by Elopak® and sold under the tradename Pur-Pak®, or other paper-derived water impermeable packaging.

Suitable containers comprise an orifice. Typically, the container comprises a cap, with the orifice typically comprised on the cap. The cap can comprise a spout, with the orifice at the exit of the spout. The spout can have a length of from 0.5 mm to 10 mm.

The orifice can have an open cross-sectional surface area at the exit of from 3 mm² to 20 mm², preferably from 3.8 mm² to 12 mm², more preferably from 5 mm² to 10 mm², wherein the container further comprises the composition according to the invention. The cross-sectional surface area is measured perpendicular to the liquid exit from the container (that is, perpendicular to the liquid flow during dispensing).

The container can typically comprise from 200 ml to 5,000 ml, preferably from 350 ml to 2000 ml, more preferably from 400 ml to 1,000 ml of the household cleaning composition.

The hand dishwashing detergent composition can be packaged in a container, typically plastic containers. Suitable containers comprise an orifice. Typically, the container comprises a cap, with the orifice typically comprised on the cap. The cap can comprise a spout, with the orifice at the exit of the spout. The spout can have a length of from 0.5 mm to 10 mm.

Alternatively, the hand dishwashing detergent composition can be packaged in an inverted container. Such inverted containers typically comprise a cap at the bottom of the container, the cap comprising either a closure or a self-sealing valve, or a combination thereof. The cap preferably comprises a self-sealing valve. Suitable self-sealing valves include slit-valves. The self-sealing valve defines a dispensing orifice that is reactively openable when the pressure on the valve interior side exceeds the pressure on the valve exterior side. The bottom dispensing container can comprise an impact resistance system, such as that described in WO2019108293A1.

### Test Methods

A) Reserve alkalinity:

Reserve alkalinity is defined as the grams of NaOH per 100 g of composition required to titrate the test composition at pH 7.0 to come to the test composition pH. The reserve alkalinity for a solution is determined in the following manner.

A pH meter (for example An Orion Model 720A) with a Ag/AgCl electrode (for example an Orion sure flow Electrode model 9172BN) is calibrated using standardized pH 7 and pH 10 buffers. A 100 g of a 10% solution in distilled water at 20° C. of the composition to be tested is prepared. The pH of the 10% solution is measured and the 100 g solution is titrated down to pH 10 using a standardized solution of 0.1 N of HCl. The volume of 0.1N HCl required is recorded in ml. The reserve alkalinity is calculated as follows:

Reserve Alkalinity=ml 0.1N HCl×0.1 (equivalent/liter)×Equivalent weight NaOH (g/equivalent)×10

B) Foam rinsing test method:

Conical centrifuge tubes (50 ml, supplied by Corning under the Falcon™ tradename) are mounted together in a placeholder rack to allow parallel measurements with matching exposure conditions. The test method was run at room temperature (22° C.).
1. 10 g of test solution for each leg, consisting of a 1.0 wt % solution of the respective detergent composition in demineralised water, is added into each tube.
2. The tubes are all shaken together 10 times in a vertical up and down direction at a speed of 2 strokes per second (1 stroke reflects a 25 cm vertical up and down motion), such that the liquid contacts once with the screw cap during each stroke movement step, in order to generate the suds.
3. Within 30 s after shaking, the initial suds volume (in ml) is determined.
4. The liquid is then decanted such that only the suds remain.
5. Then centrifuge tubes comprising the suds are gently filled via a calibrated bottle dispenser (such as a Dispensette® bottle dispenser from Sigma Aldrich) via the tube wall with 10 mL demineralized water rinse solution at the same temperature as the earlier detergent solution.
6. The tubes are again shaken all together as before in earlier step 3.
7. Within 30 s after shaking, the suds volume is remeasured and the liquid decanted again. In such a way, steps 6 till 8 represent a rinse cycle.
8. The rinse cycles are repeated up to 5 rinse cycles.
9. The percent suds height reduction after 5 rinse cycles was recorded.

### EXAMPLES

The following esteramines were prepared using the procedures described hereunder:

### butyl 6-(dimethylamino)hexanoate (Example C of Table 1)

n-butylester of N,N-dimethyl-6-amino hexane acid as methane sulfonic acid salt:

In a 4-neck vessel with thermometer, reflux condenser, nitrogen inlet, distillation head, and stirrer, 55.0 g N,N-dimethyl-6-amino hexane acid as methane sulfonic acid salt (prepared as described in U.S. Pat. No. 5,654,421) and 79.7 g n-butanol were placed and heated to 118° C. The reaction mixture was stirred for 5 hours under a constant stream of nitrogen. Water and n-butanol excess was distilled off continuously. Removal of excess n-butanol was carried out under vacuum (30 mbar) at 100° C. for 1 hour. The reaction mixture was cooled to room temperature, and 62.0 g of a light brown oil was obtained. ¹H-NMR in MeOD indicated 95.5% conversion to N,N-dimethyl-6-amino-hexane acid-butylester methane sulfonic acid salt.

### 2-ethylhexyl 6-(dimethylamino)hexanoate (Example D of Table 1)

2-ethylhexylester of N,N-dimethyl-6-amino hexane acid as methane sulfonic acid salt:

In a 4-neck vessel with thermometer, reflux condenser, nitrogen inlet, distillation head, and stirrer, 55.0 g N,N-dimethyl-6-amino hexane acid as methane sulfonic acid salt (prepared as described in U.S. Pat. No. 5,654,421) and 42.1 g 2-ethylhexanol were placed and heated to 135° C. The reaction mixture was stirred for 4 hours under a constant stream of nitrogen. Water and 2-ethylhexanol excess was distilled off continuously. Removal of excess 2-ethylhexanol was carried out under vacuum (30 mbar) at 100° C. for 1 hour. The reaction mixture was cooled to room temperature, and 82.0 g of a light brown oil was obtained. ¹H-NMR in MeOD indicated 98% conversion to N,N-dimethyl-6-amino-hexane acid-2-ethylhexylester methane sulfonic acid salt.

### Comparative Test

The following comparative test demonstrates the improvement in rinsing which is achieved by formulating the detergent composition with a non-alkoxylated esteramine of use in the present invention.

The inventive composition of example 1 comprised 1.5% of a non-alkoxylated esteramine of use in the invention. Comparative example A is a reference base product differing from the inventive examples by not comprising a non-alkoxylated esteramine.

All of the compositions provided an initial suds volume of between 30 and 35 ml.

Table 2 also includes the resultant suds volume reduction after 5 rinse cycles using the method described above.

TABLE 2
Liquid hand dishwashing detergent compositions
(example 1 of the invention, example A comparative)

| | Ex 1 | Ex A |
|---|---|---|
| | wt % | wt % |
| C12-13AE0.6S | 19.5 | 19.5 |
| C12-14 dimethyl amine oxide | 6.5 | 6.5 |
| C9-11 EO8 nonionic surfactant | 1 | 1 |
| Alkoxylated polyethyleneimine¹ | 0.44 | 0.44 |
| Sodium citrate | 0.9 | 0.9 |
| NaCl | 0.4 | 0.4 |
| Ethanol | 1.75 | 1.75 |
| 2-ethylhexyl 6-(dimethylamino)hexanoate² | 1.5 | 0 |
| pH (as 10% aqueous solution) | 8.5 | 8.5 |
| % suds height reduction after 5 cycles | 71.9% | 47.6 |

¹Polyalkoxylated polyethyleneimine (PEI) with a PEI molecular weight of about 600, substituted with 24 ethoxylate groups and 16 propoxylate groups per-NH, with a total molecular weight of about 28000 g/mol (PEI600EO24PO16), supplied by BASF
²Non-alkoxylated esteramine sample supplied by BASF

As can be seen from comparing the results of inventive example 1 with comparative example A, the incorporation of the non-alkoxylated esteramine according to the invention results in an improved rinsability.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid hand dishwashing cleaning composition comprising from about 5% to about 50% by weight of the total composition of a surfactant system wherein the surfactant system comprises:
a. an anionic surfactant
b. a co-surfactant selected from the group consisting of an amphoteric surfactant, a zwitterionic surfactant, and mixtures thereof; and
c. from about 0.1% to about 10% by weight of the composition of a non-alkoxylated esteramine, wherein the non-alkoxylated esteramine has the formula (I), or a partially or fully protonated structure thereof:
R¹—O(O)C—(CH₂)ₐ—N—(R²)₂ (I)
wherein:
R¹ is a branched or unbranched C₄-C₁₀ alkyl;
each R² is independently selected from branched or unbranched C₁-C₅ alkyl; and
index a is from 1 to 6.

2. The composition according to claim 1, wherein in the non-alkoxylated esteramine of formula (I), or a partially or fully protonated structure thereof,
a. R² is C₁-C₃ alkyl;
b. Index a is from about 1 to about 5.

3. The composition according to claim 2, wherein in the non-alkoxylated esteramine of formula (I), or a partially or fully protonated structure thereof,
a. R² is C₁ alkyl;
b. Index a is from about 2 to about 5.

4. The composition according to claim 1, wherein the non-alkoxylated esteramine is selected from the group consisting of: 3,5,5-trimethylhexyl 4-(dimethylamino)butanoate, tert-butyl 4-(dimethylamino)butanoate, butyl 6-(dimethylamino)hexanoate, 2-ethylhexyl 6-(dimethylamino)hexanoate, and mixtures thereof.

5. The composition according to claim 4, wherein the non-alkoxylated esteramine is 2-ethylhexyl 6-(dimethylamino)hexanoate.

6. The product according to claim 1, wherein the surfactant system comprises from about 0.3% to about 5.0% by weight of the composition of the non-alkoxylated esteramine, or a mixture thereof.

7. The product according to claim 6, wherein the surfactant system comprises from about 0.5% to about 2.0% by weight of the composition of the non-alkoxylated esteramine, or a mixture thereof.

8. The composition according to claim 1, wherein the liquid hand dishwashing cleaning composition comprises from about 8% to about 45% by weight of the total composition of the surfactant system.

9. The composition according to claim 1, wherein the anionic surfactant comprises at least about 70% by weight of the anionic surfactant of alkyl sulfated anionic surfactant selected from the group consisting of: alkyl sulfate, alkyl alkoxy sulfate, and mixtures thereof.

10. The composition according to claim 1, wherein the weight ratio of the anionic surfactant to the co-surfactant is from about 1:1 to about 8:1.

11. The composition according to claim 1, wherein the anionic surfactant comprises at least about 80% by weight of the anionic surfactant of alkyl sulfated anionic surfactant.

12. The composition according to claim 8, wherein the alkyl sulfated anionic surfactant is an alkyl alkoxy sulfate anionic surfactant having an average degree of alkoxylation of less than about 3.5.

13. The composition according to claim 8, wherein the alkyl sulfated anionic surfactant has a weight average degree of branching of more than about 10%.

14. The composition according to claim 1, wherein the co-surfactant is an amphoteric surfactant.

15. The composition according to claim 14, wherein the amphoteric surfactant is an amine oxide surfactant selected from the group consisting of: alkyl dimethyl amine oxide, alkyl amido propyl dimethyl amine oxide, and mixtures thereof.

16. The composition according to claim 1, wherein the co-surfactant is a zwitterionic surfactant.

17. The composition according to claim 16, wherein the zwitterionic surfactant is a betaine surfactant selected from the group consisting of alkyl betaines, alkylamidoalkylbetaine, amidazoliniumbetaine, sulfobetaine (INCI Sultaines), phosphobetaine, and mixtures thereof.

18. The composition according to claim 1, wherein the surfactant system comprises:
a. at least about 40% by weight of the surfactant system of the anionic surfactant; and
b. up to about 50% by weight of the surfactant system of the co-surfactant.

19. A method for removing grease from dishware using a liquid detergent composition wherein the liquid detergent composition comprises:
a. an anionic surfactant;
b. a co-surfactant selected from the group consisting of an amphoteric surfactant, a zwitterionic surfactant, and mixtures thereof; and
c. a non-alkoxylated esteramine, wherein the non-alkoxylated esteramine has the formula (II), or a partially or fully protonated structure thereof:
R¹—O(O)C—(CH₂)ₐ—N—(R²)₂ (II)
wherein:
R¹ is a branched or unbranched C₃-C₁₆ alkyl;
each R² is independently selected from branched or unbranched C₁-C₅ alkyl; and
index a is from 1 to 6.
